(19) United States
(12) Patent Application Publication
(10) Pub. No.: US 2026/0339154 A1
(43) Pub. Date: Oct. 29, 2026

(54) DISPLAY UNIT AND ELECTRONIC APPARATUS

(71) Applicant: SONY SEMICONDUCTOR SOLUTIONS CORPORATION, KANAGAWA (JP)

(72) Inventor: AKIHITO SATO, KANAGAWA (JP)

(21) Appl. No.: 19/114,436

(22) PCT Filed: Aug. 16, 2023
(86) PCT No.: PCT/JP2023/029559

§ 371 Date: Mar. 22, 2025

(30) Foreign Application Priority Data
Sep. 30, 2022 (JP) 2022-158947

(51) Int. Cl. G02F 1/1343; G02F 1/1333; G02F 1/1335; G03B 21/00

(52) U.S. Cl. CPC G02F 1/13439; G02F 1/133382; G02F 1/133553; G02F 1/134309; G03B 21/006

(57) ABSTRACT

A display unit according to one embodiment of the present disclosure includes: a display region where a plurality of effective pixels is disposed in a matrix form; a non-display region including a plurality of dummy pixels provided around the display region; and a heat generating structure that is provided in the non-display region in a manner surrounding the display region and absorbs incident light to generate heat.

### TECHNICAL FIELD

The present disclosure relates to, for example, a display unit that is used as a light valve of a projector and an electronic apparatus including the display unit.

### BACKGROUND ART

For example, Patent Literature 1 discloses a liquid crystal display unit that has, as a heating element, an auxiliary capacitor line formed with a thin metal film on a first substrate and has a response speed improved by heating a liquid crystal through voltage application.

### CITATION LIST

### Patent Literature

Patent Literature 1: Japanese Unexamined Patent Application Publication No. 2014-133077

### SUMMARY OF THE INVENTION

There have been demands on improvement in the image quality of display units.

It is desirable to provide a display unit and an electronic apparatus that make it possible to improve the image quality.

A display unit according to one embodiment of the present disclosure includes: a display region where a plurality of effective pixels is disposed in a matrix form; a non-display region including a plurality of dummy pixels provided around the display region; and a heat generating structure that is provided in the non-display region in a manner surrounding the display region and absorbs incident light to generate heat.

An electronic apparatus according to one embodiment of the present disclosure includes: a plurality of reflective electrodes including the display unit according to the one embodiment.

### BRIEF DESCRIPTION OF THE DRAWINGS

FIG. 1 is a schematic diagram illustrating an overall configuration of a liquid crystal display panel according to one embodiment of the present disclosure.

FIG. 2 is a schematic diagram illustrating one example of a cross-sectional configuration of a non-display region near a display region of the liquid crystal display panel illustrated in FIG. 1.

FIG. 3 is a schematic diagram illustrating one example of a planar configuration of the non-display region near the display region of the liquid crystal display panel illustrated in FIG. 2.

FIG. 4 is a schematic diagram illustrating one example of a cross-sectional configuration of a non-display region near a display region of a liquid crystal display panel as a reference example.

FIG. 5 is a schematic diagram illustrating one example of a cross-sectional configuration of a non-display region near a display region of a liquid crystal display panel according to Modification Example 1 of the present disclosure.

FIG. 6 is a schematic diagram illustrating one example of a planar configuration of the non-display region near the display region of the liquid crystal display panel illustrated in FIG. 5.

FIG. 7 is a schematic diagram illustrating one example of a cross-sectional configuration of a non-display region near a display region of a liquid crystal display panel according to Modification Example 2 of the present disclosure.

FIG. 8 is a schematic diagram illustrating one example of a planar configuration of the non-display region near the display region of the liquid crystal display panel illustrated in FIG. 7.

FIG. 9 is a schematic diagram illustrating one example of a cross-sectional configuration of a non-display region near a display region of a liquid crystal display panel according to Modification Example 3 of the present disclosure.

FIG. 10 is a schematic diagram illustrating one example of a planar configuration of the non-display region near the display region of the liquid crystal display panel illustrated in FIG. 9.

FIG. 11 is a schematic diagram illustrating one example of a cross-sectional configuration of a non-display region near a display region of a liquid crystal display panel according to Modification Example 4 of the present disclosure.

FIG. 12 is a schematic diagram illustrating one example of a planar configuration of the non-display region near the display region of the liquid crystal display panel illustrated in FIG. 11.

FIG. 13 is a schematic diagram illustrating another example of the cross-sectional configuration of the non-display region near the display region of the liquid crystal display panel according to Modification Example 4 of the present disclosure.

FIG. 14 is a schematic diagram illustrating one example of a planar configuration of the non-display region near the display region of the liquid crystal display panel illustrated in FIG. 13.

FIG. 15 is a schematic diagram illustrating another example of the cross-sectional configuration of the non-display region near the display region of the liquid crystal display panel according to Modification Example 4 of the present disclosure.

FIG. 16 is a schematic diagram illustrating one example of a planar configuration of the non-display region near the display region of the liquid crystal display panel illustrated in FIG. 15.

FIG. 17 is a schematic diagram illustrating another example of the cross-sectional configuration of the non-display region near the display region of the liquid crystal display panel according to Modification Example 4 of the present disclosure.

FIG. 18 is a schematic diagram illustrating one example of a planar configuration of the non-display region near the display region of the liquid crystal display panel illustrated in FIG. 17.

FIG. 19 is a schematic diagram illustrating one example of a cross-sectional configuration of a non-display region near a display region of a liquid crystal display panel according to Modification Example 5 of the present disclosure.

FIG. 20 is a schematic diagram illustrating one example of a cross-sectional configuration of a non-display region near a display region of a liquid crystal display panel according to Modification Example 6 of the present disclosure.

FIG. 21 is a schematic diagram illustrating one example of a planar configuration of the non-display region near the display region of the liquid crystal display panel illustrated in FIG. 20.

FIG. 22 is a functional block diagram illustrating an overall configuration of a projection-type display unit of the present disclosure.

FIG. 23 is a schematic diagram illustrating one example of a configuration of an optical system of the projection-type display unit illustrated in FIG. 22.

### MODES FOR CARRYING OUT THE INVENTION

Hereinafter, an embodiment of the present disclosure will be described in detail with reference to the drawings. The description below is one detailed example of the present disclosure and the present disclosure is not limited to modes below. Moreover, the present disclosure is not limited to dispositions, dimensions, dimensional ratios, and so on of components illustrated in the drawings. Note that order in which the description is provided is as follows.
1. Embodiment (Example of a liquid crystal display panel having a heat generating structure in a non-display region)
2. Modification Examples
   2-1. Modification Example 1 (another example of the heat generating structure)
   2-2. Modification Example 2 (another example of the heat generating structure)
   2-3. Modification Example 3 (another example of the heat generating structure)
   2-4. Modification Example 4 (another example of the heat generating structure)
   2-5. Modification Example 5 (another example of the heat generating structure)
   2-6. Modification Example 6 (another example of the heat generating structure)
3. Application Example (Example of a projection-type display unit)

### 1. Embodiment

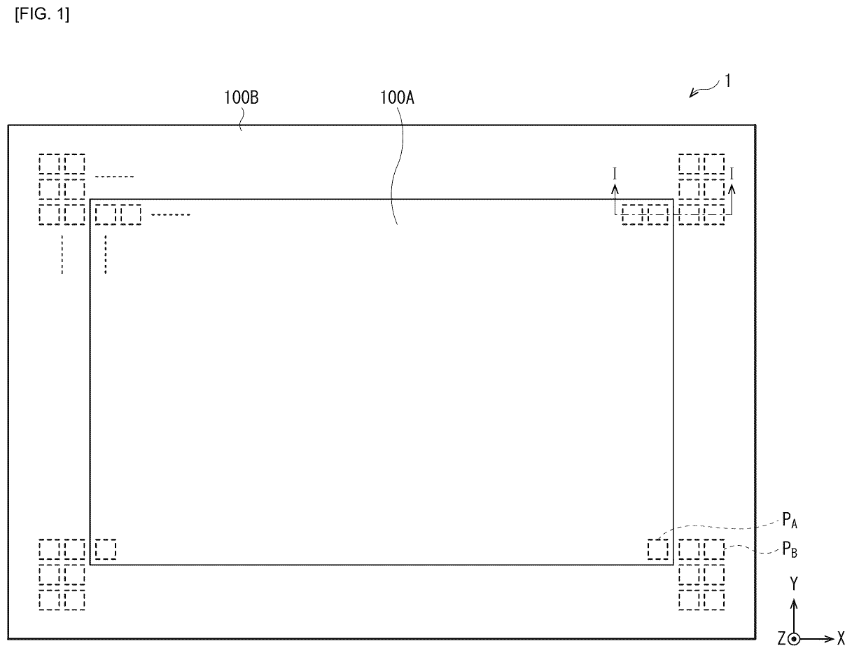

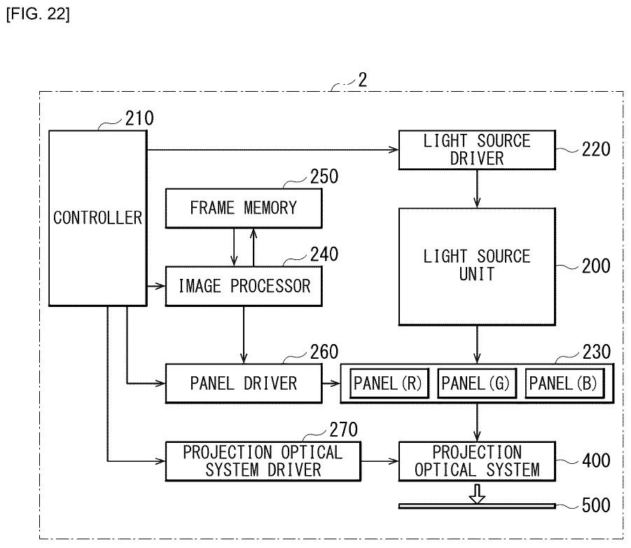

FIG. 1 schematically illustrates an overall configuration of a display unit (liquid crystal display panel 1) according to one embodiment of the present disclosure. The liquid crystal display panel 1 is used as a light valve (for example, liquid crystal panels 322A, 322B, and 322C, see FIG. 22) of a projection-type display unit (a projection-type display unit 2, see FIG. 22) such as a projector to be described later.

### Configuration of Liquid Crystal Display Panel

The liquid crystal display panel 1 has a display region 100A that is two-dimensionally disposed in the form of a matrix including a plurality of effective pixels PA and has a non-display region 100B around the display region 100A. In the non-display region 100B, a plurality of dummy pixels PB are disposed along the outer periphery of the display region 100A. A heat generating structure that absorbs incident light to generate heat is disposed in the non-display region 100B of the liquid crystal display panel 1 of the present embodiment in a manner surrounding the display region 100A, thereby uniformizing a temperature gradient within the display region 100A.

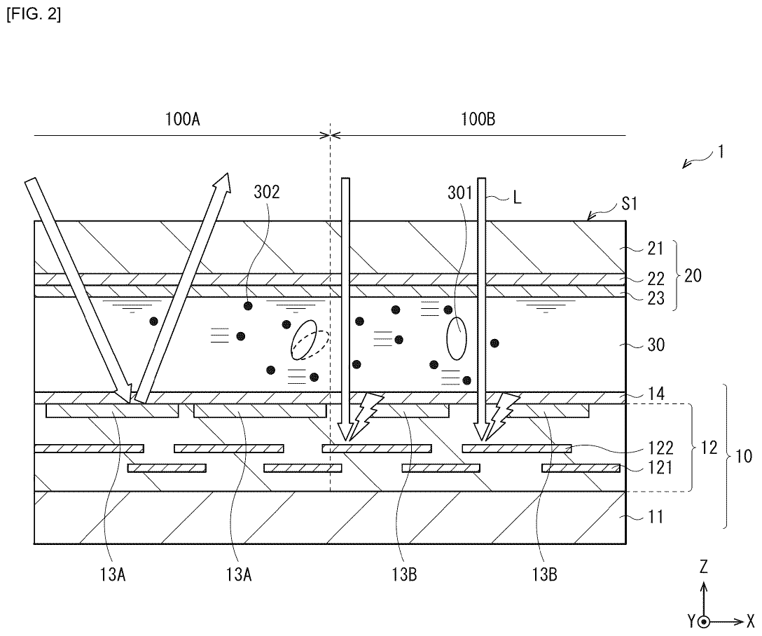

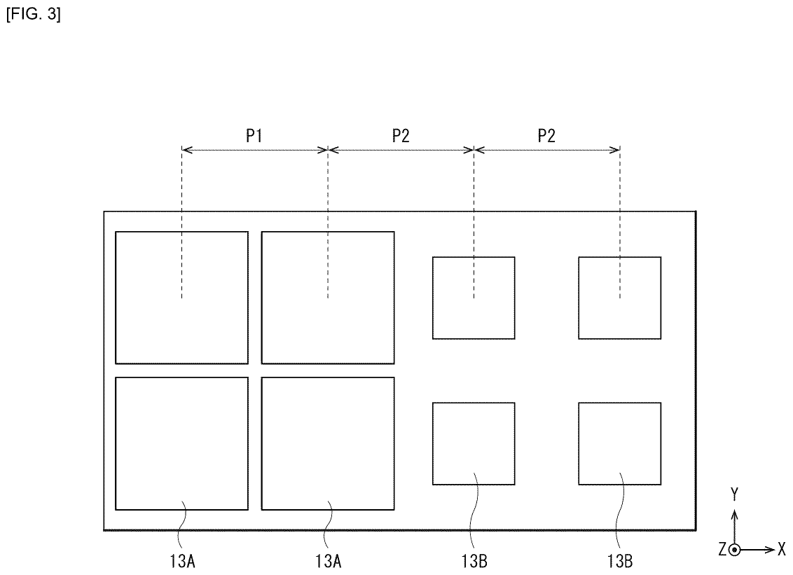

FIG. 2 schematically illustrates one example a cross-sectional configuration of the non-display region 100B near the display region 100A corresponding to line I-I illustrated in FIG. 1. FIG. 3 schematically illustrates one example of a planar configuration of the non-display region 100B near the display region 100A illustrated in FIG. 2. The liquid crystal display panel 1 has a liquid crystal layer 30 between a driving substrate 10 and a counter substrate 20 that are disposed oppositely to each other. The driving substrate 10 is provided with, for example, a pixel circuit layer 12 that includes a plurality of pixel electrodes 13A respectively provided at the plurality of effective pixels P_{A} and a plurality of dummy pixel electrodes 13B respectively provided at the plurality of dummy pixels P_{B} in the display region 100A and the non-display region 100B. The heat generating structure of the present embodiment includes: the plurality of dummy pixel electrodes 13B respectively provided at the plurality of dummy pixels P_{B}; and a wiring layer (for example, a wiring layer 122) that includes, for example, a pixel circuit and is formed in a region where the plurality of dummy pixel electrodes 13B is disposed.

Note that, the effective pixels P_{A} and the dummy pixels P_{B} are simply referred to as pixels below unless their distinction is required.

The driving substrate 10 has: for example, a substrate 11 that is formed of, for example, silicon (Si); the pixel circuit layer 12; the plurality of pixel electrodes 13A and the plurality of dummy pixel electrodes 13B; and an alignment layer 14. The pixel circuit layer 12, the plurality of pixel electrodes 13 and the plurality of the dummy pixel electrodes 13B, and the alignment layer 14 are provided on a surface of the substrate 11 on a side opposing the liquid crystal layer 30 in order just mentioned.

The pixel circuit layer 12 is provided on the substrate 11, and has: for example, a plurality of transistors that drives the liquid crystal layer 30 on an individual pixel basis; for example, the plurality of pixel electrodes 13A respectively provided at the plurality of effective pixels P_{A} and the plurality of dummy pixel electrodes 13B respectively provided and the plurality of dummy pixels P_{B} on the surface of the pixel circuit layer 12; and for example, the plurality of wiring layers 121 and 122 that electrically and respectively couples together the plurality of transistors and the plurality of pixel electrodes 13A and the plurality of dummy pixel electrodes 13B and are included in a peripheral circuit.

The wiring layers 121 and 122 are formed in order just mentioned from a substrate 11 side with an insulating layer in between. The wiring layers 121 and 122 are formed using a material with low light transmittance. It is possible as one example to form the wiring layers 121 and 122 using any of titanium nitride (TiN), molybdenum (Mo), an alloy of tungsten and molybdenum (MoW), silicon (Si), titanium (Ti), tungsten (W), zinc aluminum (ZnAl), and aluminum-doped zinc oxide (ZAO).

The plurality of pixel electrodes 13A and the plurality of dummy pixel electrodes 13B are disposed in the display region 100A and the non-display region 100B, for example, in an array for each pixel, and for example, are embedded in the surface of the pixel circuit layer 12. The plurality of pixel electrodes 13A and the plurality of dummy pixel electrodes 13B have a substantially rectangular shape. As illustrated in FIG. 3, the plurality of pixel electrodes 13A and the plurality of dummy pixel electrodes 13B are disposed at substantially the same pitch (P1=P2), a detailed description of which will be described later. On the other hand, the plurality of dummy pixel electrodes 13B has a smaller area in a XY plane direction thereof (hereinafter simply referred to as area) than the plurality of pixel electrodes 13A, and an interval between the adjacent dummy pixel electrodes 13B is wider than an interval between the adjacent pixel electrodes 13A.

The plurality of pixel electrodes 13A and the plurality of dummy pixel electrodes 13B are formed using a meal material such as, for example, aluminum (Al), titanium (Ti), copper (Cu), silicon (Si), silver (Ag), or any of alloys thereof (for example, an Al-Cu alloy and an Al-Si alloy) that has light reflectivity and is mainly made of a low-resistance metal. The plurality of pixel electrodes 13A and the plurality of dummy pixel electrodes 13B have a film thickness (hereinafter simply referred to as a thickness) of, for example, more than or equal to 50 nm and less than or equal to 2000 nm in a stacking direction (a z-axis direction).

The alignment layer 14 performs alignment control of the liquid crystal layer 30 and is formed by an inorganic material such as, for example, silicon oxide (SiO₂), diamond-like carbon, or aluminum oxide (Al₂O₃). The alignment layer 14 has a thickness of, for example, more than or equal to 50 nm and less than or equal to 500 nm. It is possible to form the alignment layer 14 through, for example, a vapor deposition method.

The counter substrate 20 has, for example, a substrate 21 having light transmittance, a counter electrode 22, and an alignment layer 23. The counter electrode 22 and the alignment layer 23 are provided on a surface of the substrate 21 on side opposing the liquid crystal layer 30 in order just mentioned.

The counter electrode 22 extends to, for example, from the display region 100A to an area above the dummy pixels P_{B} of the non-display region 100B as, for example, a common electrode for all the pixels. The counter electrode 22 is formed by, for example, a conductive material having light transmittance. Examples of the conductive material having light transmittance include an indium tin oxide (ITO), an indium zinc oxide (IZO), a zinc oxide (ZnO), an indium gallium zinc-containing oxide (IGZO), and so on.

The alignment layer 23 performs alignment control of the liquid crystal layer 30 and is formed by an inorganic material such as, for example, silicon oxide (SiO₂), diamond-like carbon, or aluminum oxide (Al₂O₃). The alignment layer 23 has a thickness of, for example, more than or equal to 50 nm and less than or equal to 500 nm. It is possible to form the alignment layer 23 using, for example, a vapor deposition method.

The liquid crystal layer 30 includes liquid crystals that are driven by, for example, a VA (Vertical Alignment) mode, a TN (Twisted Nematic) mode, an ECB (Electrically Controlled Birefringence) mode, an FFS (Fringe Field Switching) mode, or an IPS (In Plane Switching) mode. The liquid crystal layer 30 is sealed with, for example, a commercially available thermosetting or UV curable sealing material for LCD displays that attaches the drive substrate 10 and the counter substrate 20 to each other. The liquid crystal layer 30 is sealed with, for example, the UV curable sealing material as a result of injecting liquid crystals after the attachment of the drive substrate 10 and the counter substrate 20 to each other with a sealing material. Alternatively, the liquid crystal layer 30 may be manufactured using, for example, an ODF (One Drop Fill) process. The liquid crystal layer 30 is configured to receive an image voltage supplied by the plurality of pixel electrodes 13 and the counter electrode 22.

### Configuration of Heat Generating Structure

The heat generating structure of the present embodiment includes: the plurality of dummy pixel electrodes 13B respectively provided at the plurality of dummy pixels P_{B}; and the wiring layer (for example, the wiring layer 122) that is included in, for example, a pixel circuit and is formed in the region where the plurality of dummy pixel electrodes 13B is disposed, as described above. Specifically, the plurality of dummy pixel electrodes 13B correspond to one detailed example of “a second reflective electrode” of the present disclosure, and the wiring layer 122 corresponds to one detailed example of “a first metal film” of the present disclosure. Moreover, the plurality of pixel electrodes 13A corresponds to one detailed example of “a first reflective electrode” of the present disclosure.

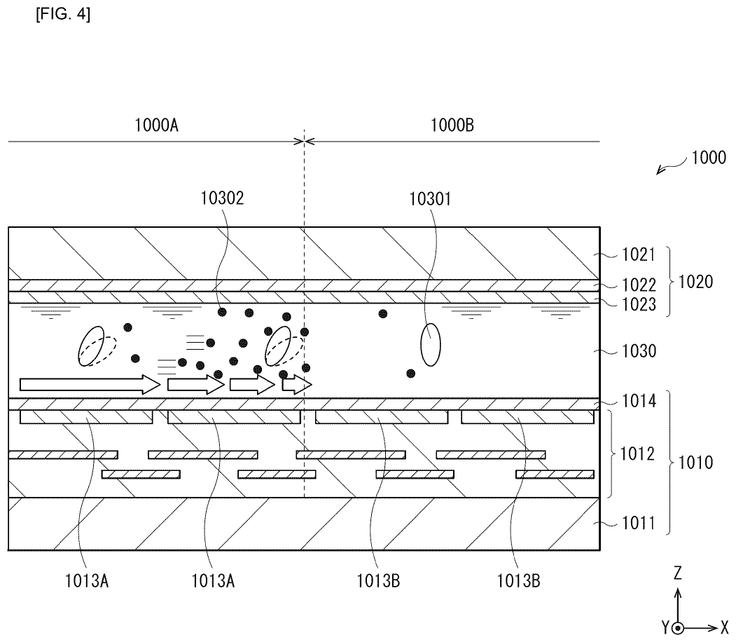

FIG. 4 schematically illustrates a cross-sectional configuration of a non-display region 1000B near a display region 1000A of a typical liquid crystal display panel 1000 as a reference example. The liquid crystal display panel 1000 has a liquid crystal layer 1030 between a drive substrate 1010 and a counter substrate 1020 which are disposed oppositely to each other. The drive substrate 10 has: for example, a substrate 1011, a pixel circuit layer 1012, a plurality of pixel electrodes 1013A and a plurality of dummy pixel electrodes 1013B, and an alignment layer 1014. The counter substrate 20 has, for example, a substrate 1021, a counter electrode 1022, and an alignment layer 1023.

The liquid crystal display panel has a disadvantage in that, for example, display unevenness or flicker is caused by light generated within a display surface or retention of impurity ions generated through thermal decomposition, leading to display performance deterioration. In the typical liquid crystal display panel 1000, the impurity ions are pushed out towards the non-display region 100B by convention caused by driving liquid crystal molecules 10301 of the peripheral pixels. However, the non-display region 1000B has a lower temperature and higher viscosity than the display region 1000A due to in-plane distribution of incident light. Thus, as illustrated in FIG. 4, impurities 10302 generated in the display region 1000A are not discharged towards the non-display region 100B but stays, causing, for example, display unevenness or flicker, which deteriorates display performance. Moreover, the impurities 10302 react with the liquid crystal molecules 10301, reducing a life span of the liquid crystals.

On the contrary, in the liquid crystal display panel 1, the plurality of pixel electrodes 13A and the plurality of dummy pixel electrodes 13B are disposed at substantially the same pitch (P1=P2), as illustrated in FIG. 3. On the other hand, the plurality of dummy pixel electrodes 13B has a smaller area than the plurality of pixel electrodes 13A, and the interval between the adjacent dummy pixel electrodes 13B is wider than the interval between the adjacent pixel electrodes 13A. The wiring layers 121 and 122 are formed below the plurality of pixel electrodes 13A and the plurality of dummy pixel electrodes 13B. For example, the wiring layers 121 and 122 are laid out to fill a gap between the electrodes 13A and 13B in plan view to allow the blocking of light L that is incident from a light incidence side S1 towards the drive substrate 10 through between the electrodes 13A and 13B is blocked.

As described above, in the present embodiment, the area of the plurality of dummy pixel electrodes 13B is reduced, the interval between the adjacent dummy pixel electrodes 13B including a border between the pixel electrode 13A and the dummy pixel electrode 13B is enlarged, and the wiring layers 121 and 122 are formed using a material that has lower reflectance than the electrodes 13A and 13B and has low light transmittance. As a result, as illustrated in FIG. 2, more light L is absorbed by the wiring layers 121 and 122 through between the adjacent dummy pixel electrodes 13B in the non-display region 100B near the display region 100A than the display region 100A, causing heat generation. Therefore, a temperature near the non-display region 100B increases, that is, an in-plane temperature gradient of the display region 100A and the non-display region 100B is uniformized. This therefore promotes the discharge of the impurities 302 towards the non-display region 100B, which reduces the occurrence of display unevenness and flicker caused by leakage originating from the impurities 302. Moreover, reaction between the liquid crystal molecules 301 and the impurities 302 is suppressed, improving the life span of the liquid crystals.

### Actions and Effects

As described above, in the liquid crystal display panel 1 of the present embodiment, the area of the plurality of dummy pixel electrodes 13B is reduced and the interval between the adjacent dummy pixel electrodes 13B including the border between the pixel electrode 13A and the dummy pixel electrode 13B is increased, and the light passing through between the adjacent dummy pixel electrodes 13B is absorbed in the wiring layers 121 and 122 formed below the dummy pixel electrodes 13B, causing heat generation. This consequently uniformizes the in-plane temperature gradient of the display region 100A and the non-display region 100B and promotes the discharge of the impurities 302 towards the non-display region 100B. Therefore, it is possible to suppress the occurrence of display unevenness and flicker caused by leak originating from the impurities 302.

Therefore, with the liquid crystal display panel 1, it is possible to improve image quality. It is also possible to suppress the reaction between the liquid crystal molecules 301 and the impurities 302, which allows improvement in the life span of the liquid crystals.

Next, Modification Examples 1 to 6 of the present disclosure will be described. Note that the same components as those of the liquid crystal display panel 1 in the embodiment described above are provided with the same numerals, the description of which will be omitted when appropriate.

### 2. Modification Examples

### 2-1. Modification Example 1

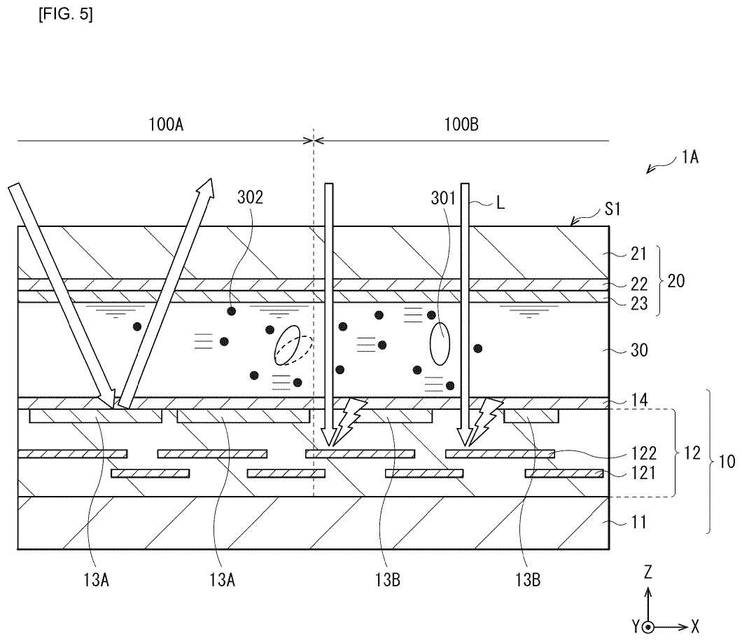

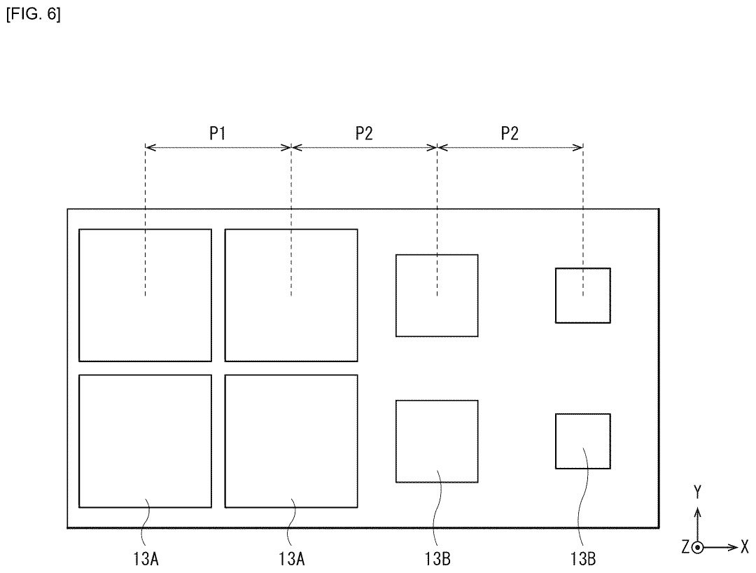

FIG. 5 schematically illustrates one example of a cross-sectional configuration of a non-display region 100B near a display region 100A of a display unit (liquid crystal display panel 1A) according to Modification Example 1 of the present disclosure. FIG. 6 schematically illustrates one example of a planar configuration of the non-display region 100B near the display region 100A illustrated in FIG. 5. As is the case with the embodiment described above, the liquid crystal display panel 1A is used as a light valve (for example, the liquid crystal panels 322A, 322B, and 322C) of the projection type display unit 2 such as a projector to be described later.

Illustrated in the embodiment described above is an example in which the heat generating structure includes: the plurality of dummy pixel electrodes 13B that is arrayed at substantially the same pitch as a pitch of the plurality of pixel electrodes 13A (P1=P2) and has a smaller area than the plurality of pixel electrodes 13A; and the wiring layer (for example, the wiring layer 122) that is provided below the plurality of dummy pixel electrodes 13B and is included in, for example, the pixel circuit. On the contrary, in the liquid crystal display panel 1A of the present modification example, an area of a plurality of dummy pixel electrodes 13B is reduced with an increase in a distance from the display region 100A.

Specifically, in the liquid crystal display panel 1A, while the plurality of pixel electrodes 13A and the plurality of dummy pixel electrodes 13B are disposed at substantially the same pitch (P1=P2) as illustrated in FIG. 6, the plurality of dummy pixel electrodes 13B has a smaller area than the plurality of pixel electrodes 13A and an interval between the adjacent dummy pixel electrodes 13B is wider with an increase in the distance from the display region 100A. Consequently, light absorbed by the wiring layers 121 and 122 through between the adjacent dummy pixel electrodes 13B increases with an increase in the distance from the display region 100A, causing greater heat generation with an increase in the distance from the display region 100A.

As described above, in the liquid crystal display panel 1A of the present example, the temperature gradient in the plane of the display region 100A and the non-display region 100B is more uniformized, promoting more discharge of impurities 302 towards the non-display region 100B. This therefore makes it possible to achieve further improvement in image quality with the liquid crystal display panel 1A than with the liquid crystal display panel 1 of the embodiment described above. It is also possible to suppress reaction between liquid crystal molecules 301 and the impurities 302, thus allowing further improvement in a life span of liquid crystals.

### 2-2. Modification Example 2

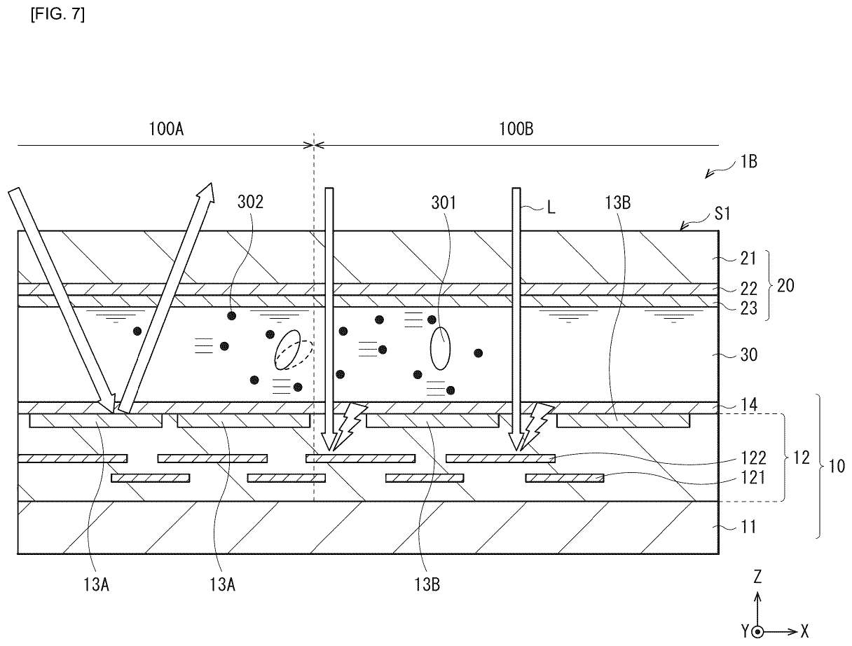

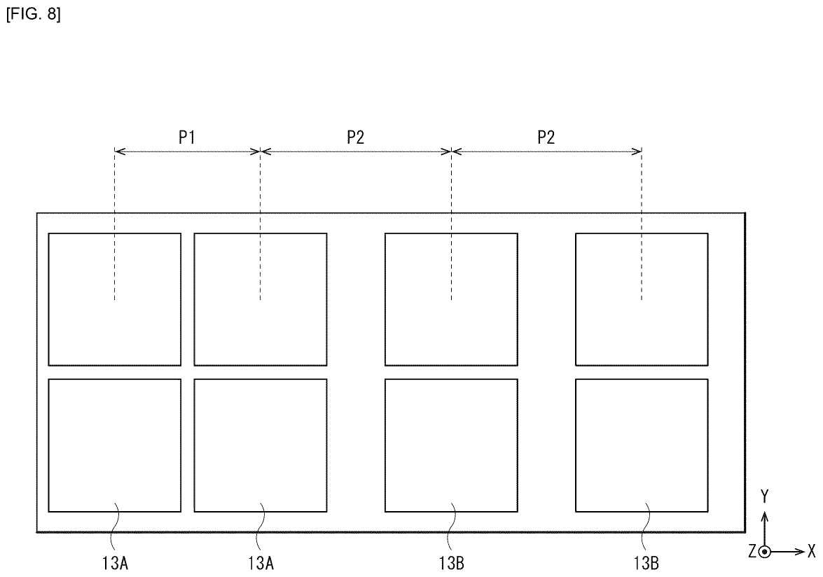

FIG. 7 schematically illustrates one example of a cross-sectional configuration of a non-display region 100B near a display region 100A of a display unit (liquid crystal display panel 1B) according to Modification Example 2 of the present disclosure. FIG. 8 schematically illustrates one example of a planar configuration of the non-display region 100B near the display region 100A illustrated in FIG. 7. As is the case with the embodiment described above, the liquid crystal display panel 1B is used as a light valve (for example, the liquid crystal panels 322A, 322B, and 322C) of the projection type display unit 2 such as a projector to be described later.

Illustrated in the embodiment described above is the example in which the heat generating structure includes: the plurality of dummy pixel electrodes 13B that is arrayed at substantially the same pitch as the pitch of the plurality of pixel electrodes 13A (P1=P2) and has a smaller area than the plurality of pixel electrodes 13A; and the wiring layer (for example, the wiring layer 122) that is provided below the plurality of dummy pixel electrodes 13B and is included in, for example, the pixel circuit. On the contrary, in the liquid crystal display panel 1B of the present modification example, a plurality of pixel electrodes 13A and a plurality of dummy pixel electrodes 13B have substantially the same area, and a pitch (P2) of the plurality of dummy pixel electrodes 13B is wider than a pitch (P1) of the plurality of pixel electrodes 13A (P1<P2), as illustrated in FIG. 8.

Specifically, in the liquid crystal display panel 1B, the plurality of pixel electrodes 13A and the plurality of dummy pixel electrodes 13B have substantially the same area while the pitch (P2) of the plurality of dummy pixel electrodes 13B is wider than the pitch (P1) of the plurality of pixel electrodes 13A (P1<P2) and an interval between the adjacent dummy pixel electrodes 13B is wider than an interval of the adjacent pixel electrodes 13A, as illustrated in FIG. 8. Consequently, more light L is absorbed to the wiring layers 121 and 122 through the adjacent dummy pixel electrodes 13B in the non-display region 100B near the display region 100A than in the display region 100A, causing heat generation.

As described above, in the liquid crystal display panel 1B of the present modification example, a temperature gradient in a plane of the display region 100A and the non-display region 100B is uniformized, promoting more discharge of impurities 302 towards the non-display region 100B. This therefore makes it possible to achieve improvement in the image quality with the liquid crystal display panel 1B, as is the case with the liquid crystal display panel 1 of the embodiment described above. It is also possible to suppress reaction between liquid crystal molecules 301 and the impurities 302, thus allowing further improvement in a life span of liquid crystals.

### 2-3. Modification Example 3

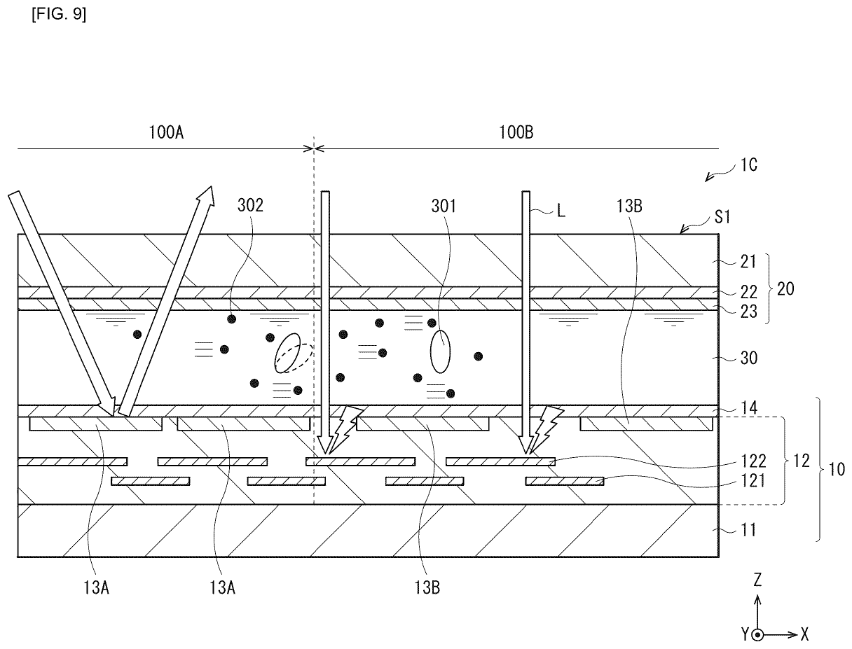

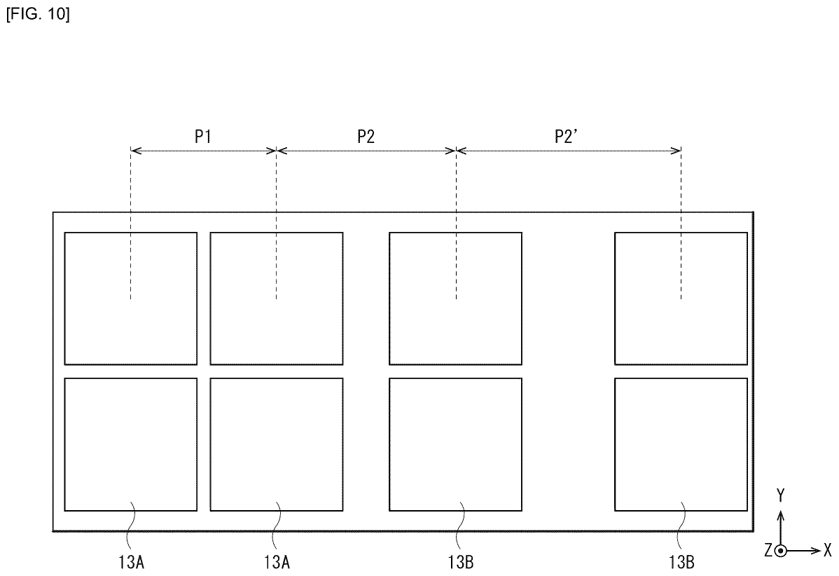

FIG. 9 schematically illustrates one example of a cross-sectional configuration of a non-display region 100B near a display region 100A of a display unit (liquid crystal display panel 1C) according to Modification Example 3 of the present disclosure. FIG. 10 schematically illustrates one example of a planar configuration of the non-display region 100B near the display region 100A illustrated in FIG. 9. As is the case with the embodiment described above, the liquid crystal display panel 1C is used as a light valve (for example, the liquid crystal panels 322A, 322B, and 322C) of the projection type display unit 2 such as a projector to be described later.

Illustrated in Modification Example 2 described above is an example in which the heat generating structure includes: the plurality of dummy pixel electrodes 13B that has substantially the same area as the plurality of pixel electrodes 13A and are arrayed at a wider pitch than the plurality of pixel electrodes 13A; and the wiring layer (for example, the wiring layer 122) that is provided below the plurality of dummy pixel electrodes 13B and is included, for example, the pixel circuit. On the contrary, in the liquid crystal display panel 1C of the present modification example, pitches (P2 and P2′) of a plurality of dummy pixel electrodes 13B is wider with an increase in a distance from a display region 100A (P2<P2′), as illustrated in FIG. 10.

Specifically, in the liquid crystal display panel 1C, a plurality of pixel electrodes 13A and the plurality of dummy pixel electrodes 13B have substantially the same area while the pitches (P2 and P2′) of the plurality of dummy pixel electrodes 13B are wider with an increase in the distance from the display region 100A (P2<P2′) and an interval between the adjacent dummy pixel electrodes 13B is wider with an increase in the distance from the display region 100A, as illustrated in FIG. 10. Consequently, light absorbed to the wiring layers 121 and 122 through the adjacent dummy pixel electrodes 13B increases with an increase in the distance from the display region 100A, causing greater heat generation with an increase in the distance from the display region 100A.

As described above, in the liquid crystal display panel 1C of the present modification example, a temperature gradient in a plane of the display region 100A and the non-display region 100B is more uniformized, promoting more discharge of impurities 302 towards the non-display region 100B. This therefore makes it possible to achieve further improvement in image quality with the liquid crystal display panel 1C than with the liquid crystal display panel 1 of the embodiment described above. It is also possible to suppress reaction between liquid crystal molecules 301 and the impurities 302, thus allowing further improvement in a life span of liquid crystals.

### 2-4. Modification Example 4

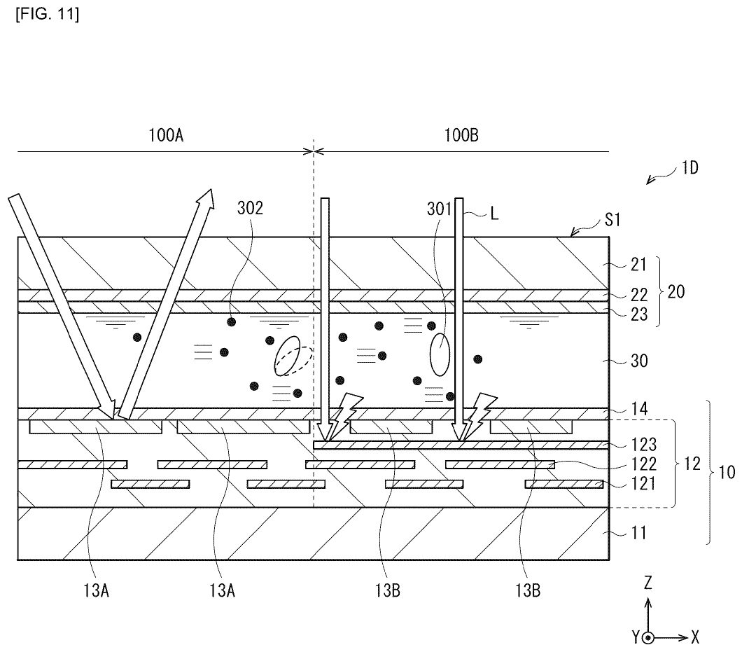

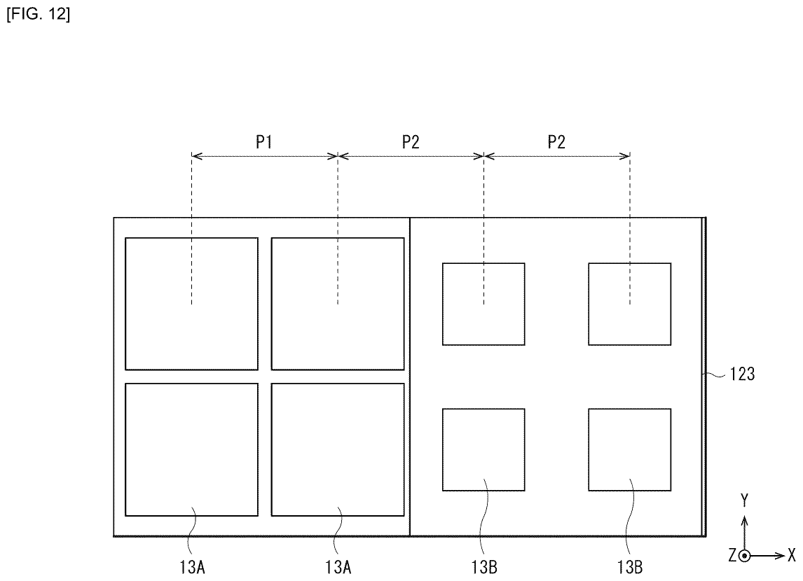

FIG. 11 schematically illustrates one example of a cross-sectional configuration of a non-display region 100B near a display region 100A of a display unit (liquid crystal display panel 1D) according to Modification Example 4 of the present disclosure. FIG. 12 schematically illustrates one example of a planar configuration of the non-display region 100B near the display region 100A illustrated in FIG. 5. As is the case with the embodiment described above, the liquid crystal display panel 1D is used as a light valve (for example, the liquid crystal panels 322A, 322B, and 322C) of the projection type display unit 2 such as a projector to be described later.

Illustrated in the embodiment described above is the example in which the heat generating structure includes: the plurality of dummy pixel electrodes 13B that is arrayed at substantially the same pitch as the pitch of the plurality of pixel electrodes 13A (P1=P2) and has a smaller area than the plurality of pixel electrodes 13A; and the wiring layer (for example, the wiring layer 122) that is provided below the plurality of dummy pixel electrodes 13B and is included in, for example, the pixel circuit. On the contrary, in the liquid crystal display panel 1D of the present modification example, a metal film 123, which is electrically floating, is provided between a plurality of dummy pixel electrodes 12B and the wiring layers 121 and 122 that are included in the pixel circuit, and the metal film 123 and the plurality of dummy pixel electrodes 13B respectively provided at the plurality of dummy pixels PB form a heat generating structure.

The metal film 123 corresponds to one detailed example of “a first metal film” of the present disclosure. The metal film 123 is formed using a material with low light transmittance, as is the case with the wiring layers 121 and 122. As one example, it is possible to form the metal film 123 using any of titanium nitride (TiN), molybdenum (Mo), an alloy of tungsten and molybdenum (MoW), silicon (Si), titanium (Ti), tungsten (W), zinc aluminum (ZnAl), and aluminum-doped zinc oxide (ZAO).

As described above, in the liquid crystal display panel 1D of the present modification example, a temperature gradient in a plane of the display region 100A and the non-display region 100B is uniformized, promoting more discharge of impurities 302 towards the non-display region 100B. This therefore makes it possible to achieve improvement in image quality with the liquid crystal display panel 1D, as is the case with the liquid crystal display panel 1 of the embodiment described above. It is also possible to suppress reaction between liquid crystal molecules 301 and the impurities 302, thus allowing further improvement in a life span of liquid crystals.

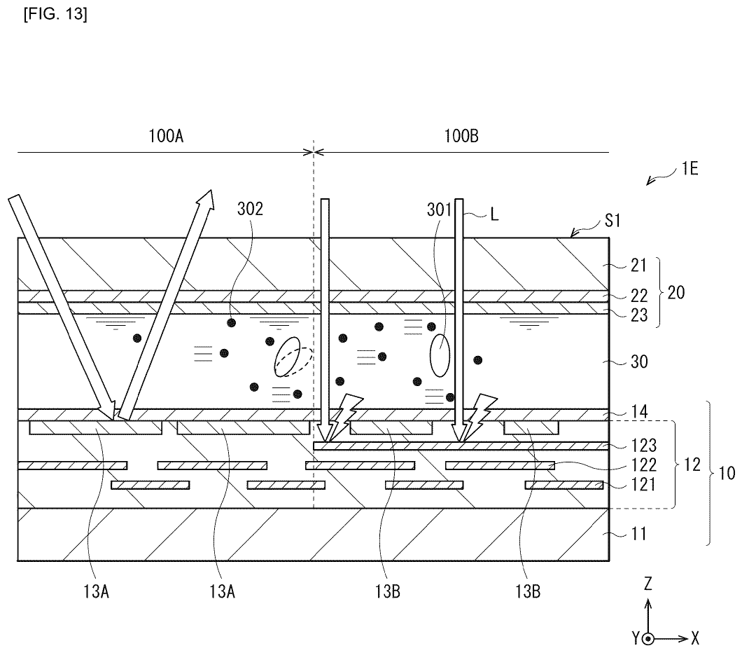

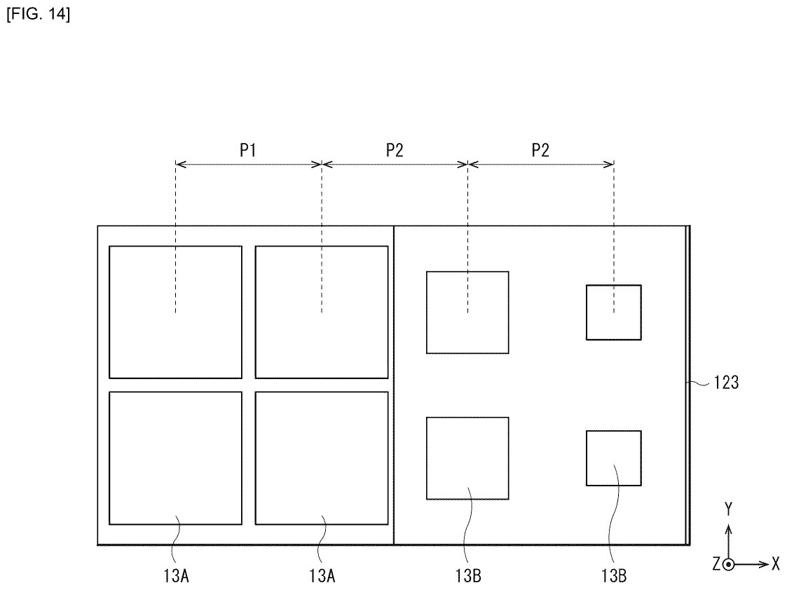

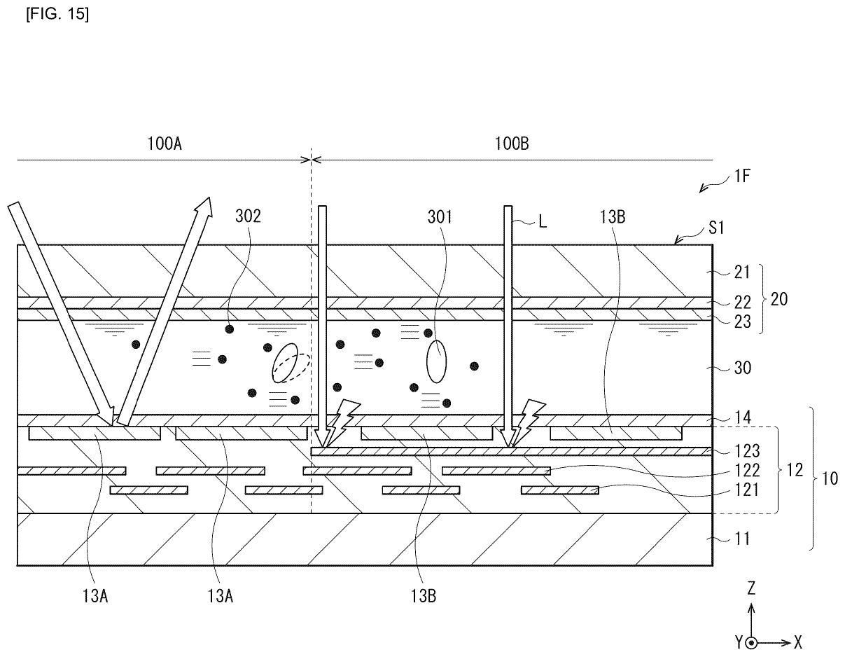

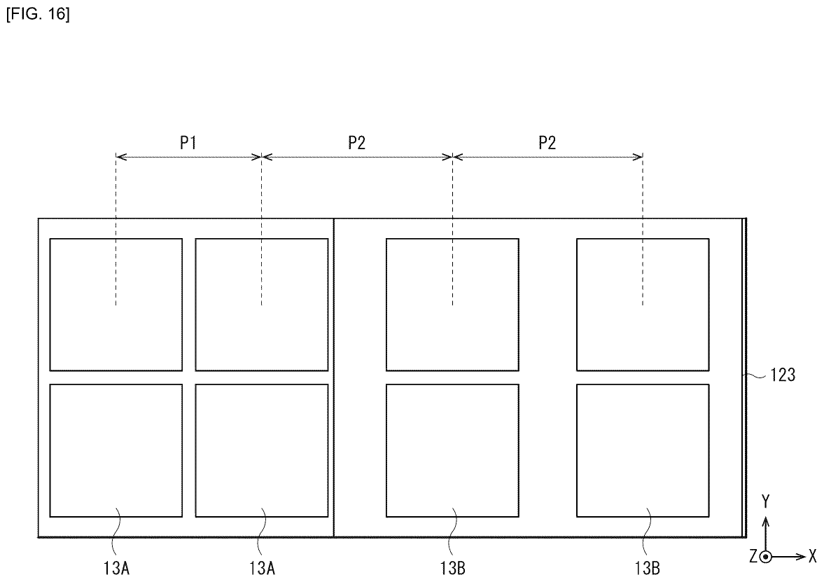

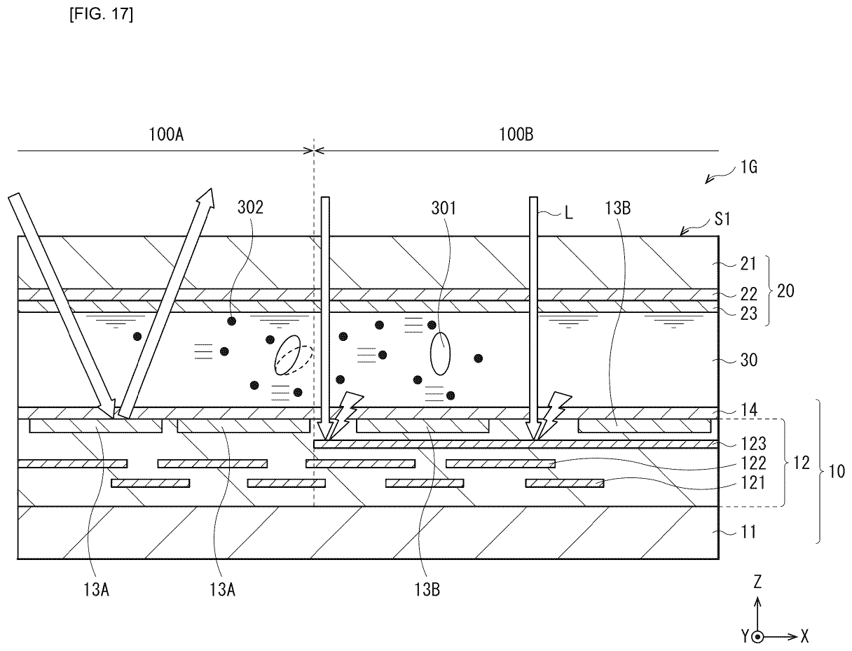

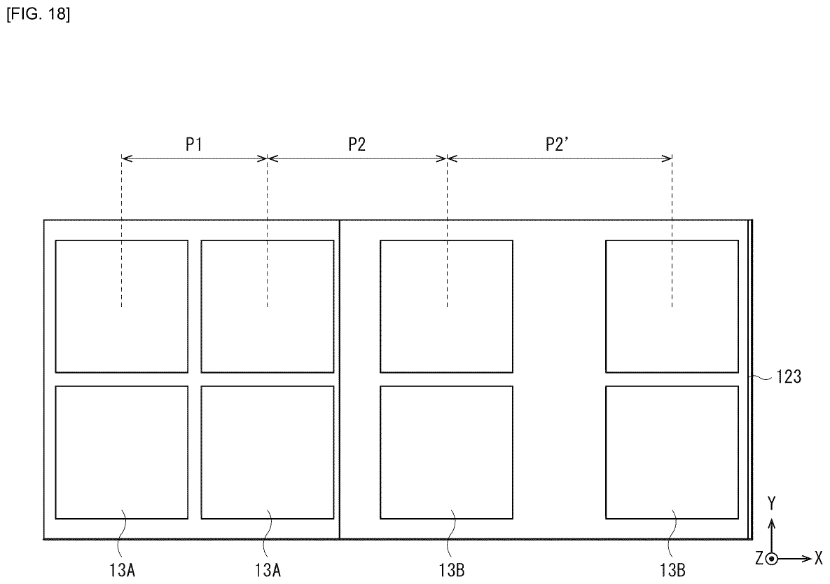

Note that it is possible to achieve the present configuration by combining Modification Examples 1 to 3 described above. Specifically, as is the case with a liquid crystal display panel 1E illustrated in FIGS. 13 and 14, pitches (P1 and P2) of a plurality of pixel electrodes 13A and a plurality of dummy pixel electrodes 13B may be substantially the same (P1=P2), and an area of the plurality of dummy pixel electrodes 13B may be smaller with an increase in a distance from the display region 100A. Moreover, as is the case with a liquid crystal display panel 1F illustrated in FIGS. 15 and 16, a plurality of pixel electrodes 13A and a plurality of dummy pixel electrodes 13B may have substantially the same area, and a pitch (P2) of the plurality of dummy pixel electrodes 13B may be wider than a pitch (P1) of the plurality of pixel electrodes 13A (P1<P2). Moreover, as is the case with a liquid crystal display panel 1G illustrated in FIGS. 17 and 18, a plurality of pixel electrodes 13A and a plurality of dummy pixel electrodes 13B may have substantially the same area, and further pitches (P2 and P2′) of the plurality of dummy pixel electrodes 13B may be wider with an increase in a distance from a display region 100A (P2<P2′). This makes it possible to provide the same effects as those provided by Modification Examples 1 to 3 described above.

### 2-5. Modification Example 5

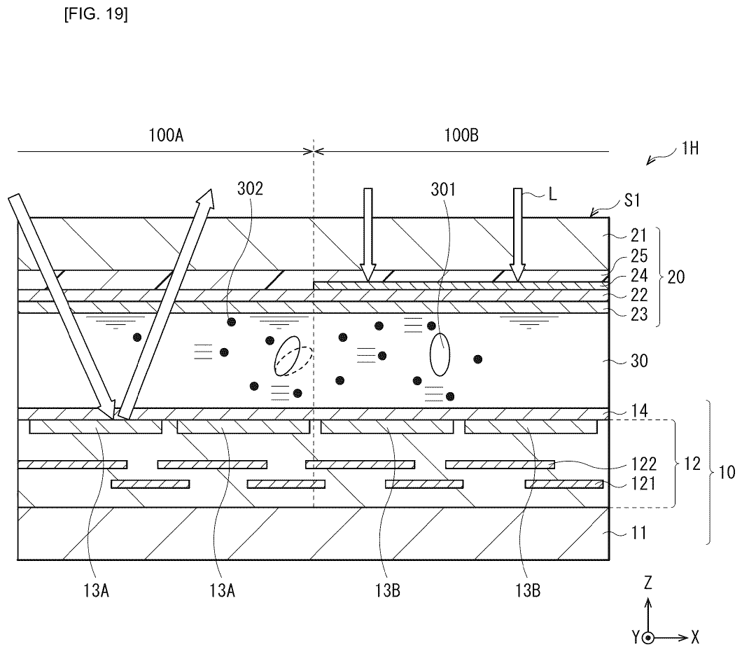

FIG. 19 schematically illustrates one example of a cross-sectional configuration of a non-display region 100B near a display region 100A of a display unit (liquid crystal display panel 1H) according to Modification Example 5 of the present disclosure. As is the case with the embodiment described above, the liquid crystal display panel 1H is used as a light valve (for example, the liquid crystal panels 322A, 322B, and 322C) of the projection type display unit 2 such as a projector to be described later.

Illustrated in the embodiment described above is the example in which the heat generating structure is provided on a drive substrate 10 side. On the contrary, a heat generating structure is provided on an opposing substrate 20 side in the liquid crystal display panel 1G of the present modification example.

Specifically, as illustrated in FIG. 19, in the liquid crystal display panel 1G, a meatal film 24 is provided on a counter electrode 22 in the non-display region 100B near the display region 100A, more specifically, a region where a plurality of pixels P_{B} are disposed. Consequently, light L incident from a light incidence side S1 is absorbed at the meatal film 24 in the non-display region 100B near the display region 100A, causing heat generation.

The metal film 24 corresponds to one detailed example of “a second metal film” of the present disclosure. The metal film 24 is formed using a material with low light transmittance, as is the case with the wiring layers 121 and 122. As one example, it is possible to form the metal film 24 using any of titanium nitride (TiN), molybdenum (Mo), an alloy of tungsten and molybdenum (MoW), silicon (Si), titanium (Ti), tungsten (W), zinc aluminum (ZnAl), and aluminum-doped zinc oxide (ZAO).

As described above, in the liquid crystal display panel 1G of the present Modification Example, a temperature gradient in a plane of the display region 100A and the non-display region 100B is uniformized, promoting more discharge of impurities 302 towards the non-display region 100B. This therefore makes it possible to achieve improvement in image quality with the liquid crystal display panel 1G, as is the case with the liquid crystal display panel 1 of the embodiment described above. It is also possible to suppress reaction between liquid crystal molecules 301 and the impurities 302, thus allowing further improvement in a life span of liquid crystals.

### 2-6. Modification Example 6

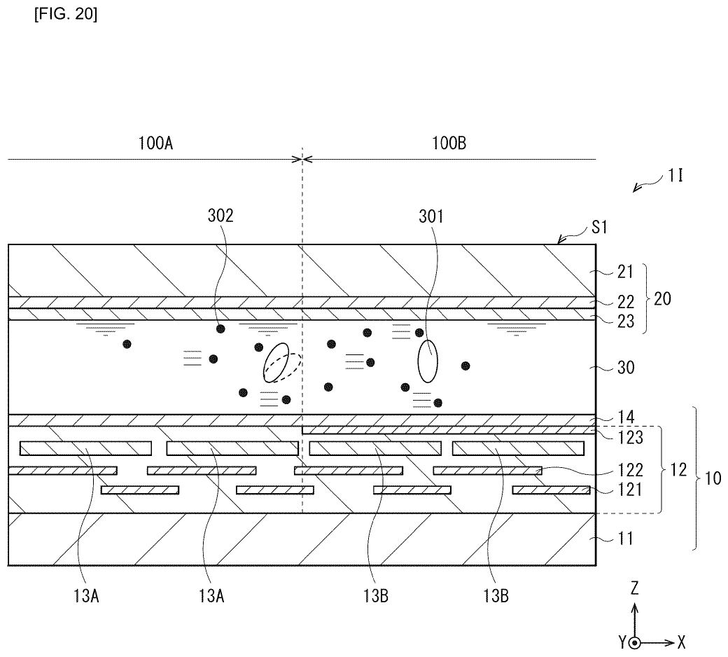

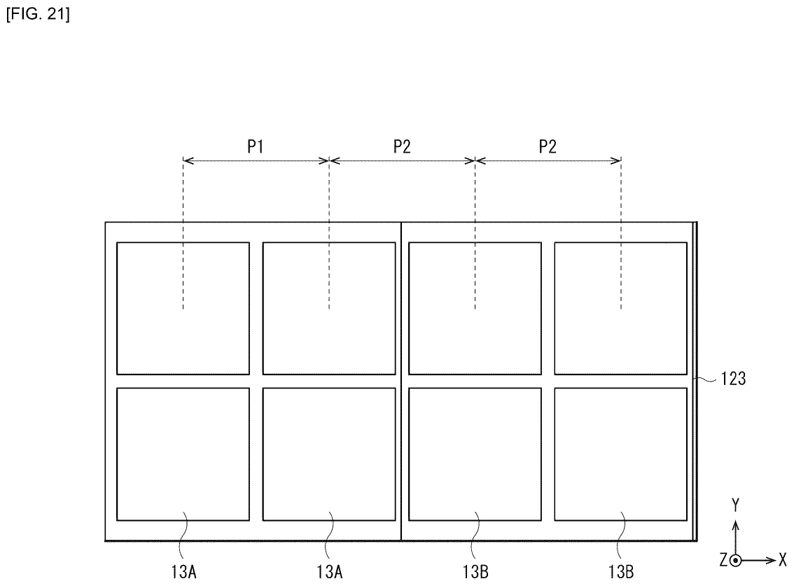

FIG. 20 schematically illustrates one example of a cross-sectional configuration of a non-display region 100B near a display region 100A of a display unit (liquid crystal display panel 1I) according to Modification Example 4 of the present disclosure. FIG. 21 schematically illustrates one example of a planar configuration of the non-display region 100B near the display region 100A illustrated in FIG. 20. As is the case with the embodiment described above, the liquid crystal display panel 1I is used as a light valve (for example, the liquid crystal panels 322A, 322B, and 322C) of the projection type display unit 2 such as a projector to be described later.

Illustrated in Modification Example 4 described above is an example in which the metal film 123, which is electrically floating, is provided between the plurality of dummy pixel electrodes 12B and the wiring layers 121 and 122 that are included in the pixel circuit, but the metal film 123 may be provided above the plurality of dummy pixel electrodes 13B, as illustrated in FIG. 20. In the aforementioned case, it is possible to provide a plurality of dummy pixel electrodes 13B having substantially the same pitch and substantially the same area as those of the plurality of pixel electrodes 13A, as illustrated in FIG. 21.

As described above, in the liquid crystal display panel 1I of the present example, a temperature gradient in a plane of the display region 100A and the non-display region 100B is uniformized, promoting more discharge of impurities 302 towards the non-display region 100B. This therefore makes it possible to achieve improvement in image quality with the liquid crystal display panel 1I, as is the case with the liquid crystal display panel 1 of the embodiment described above. It is also possible to suppress reaction between liquid crystal molecules 301 and the impurities 302, thus allowing further improvement in a life span of liquid crystals.

### 3. Application Example

FIG. 22 is a functional block diagram illustrating an entire configuration of a display unit (a projection-type display unit 2) according to Application Example 1. The projection-type display unit 2 is, for example, a display unit which projects an image on a screen 500 (a projection surface). The projection-type display unit 2 is connected to an external image supply unit such as, for example, a computer such as a PC or any of various image players, not illustrated, via an I/F (interface), and performs projection on the screen 500 based on an image signal inputted to the interface.

The projection-type display unit 2 includes: for example, a light source unit 200, a controller 210, a light source driver 220, an optical modulator 230, an image processor 240, a frame memory 250, a panel driver 260, a projection optical system driver 270, and a projection optical system 400.

The light source unit 200 includes: a light source driver that drives a light source; and a current value setting section that sets each current value upon the driving of the light source, which are not specifically illustrated. Based on a power source supplied from a power supply circuit, not illustrated, the light source driver generates a current with the current value set by the current value setting section in synchronization with a signal inputted from the light source driver 220. Each of the generated currents is supplied to the light source.

The controller 210 controls the light source driver 220, the image processor 240, the panel driver 260, and the projection optical system driver 270.

The light source driver 220 outputs a signal for controlling light emission timing of the light source disposed at the light source unit 200. The light source driver 220 includes: for example, a PWM setting section, a PWM signal generator, a limiter, and so on, not illustrated, and controls the light source driver of the light source unit 200 based on the control performed by the controller 210 and performs PWM control on the light source to thereby turn on and off the light source or adjust luminance

The optical modulator 230 modulates light (illumination light) outputted from the light source unit 200 based on an image signal to generate image light. The optical modulator 230 is configured to include, for example, three light valves (for example, the liquid crystal display panel 1 described above) respectively corresponding to RGB colors to be described later. Listed as an example thereof include: a liquid crystal display panel (liquid crystal panel (B)) that modulates blue light (B); a liquid crystal display panel (liquid crystal panel (R)) that modulates red light (R); and a liquid crystal display panel (liquid crystal panel (G)) that modulates green light (G). Synthesis by, for example, a cross dichroic prism, not illustrated, is performed for light of each of the RGB colors modulated by the optical modulator 230 and the light is guided to the projection optical system 400.

The image processor 240 acquires an image signal inputted from an outside and performs: judgment on an image size; judgment on resolution; judgment on whether an image is a still image or a moving image; and so on. In a case where the image is a moving image, attributes (such as a flame rate) and so on of image data are also determined. Moreover, in a case where the resolution of the acquired image signal is different from display resolution of each of the liquid crystal panels of the optical modulator 230, resolution conversion processing is performed. The image processor 240 explores the image subjected to each of the processing in the frame memory 250 for each frame, and also outputs, as a display signal, the image explored in the frame memory 250 for each frame to the panel driver 260.

The panel driver 260 drives each of the liquid crystal panels R, G, and B of the optical modulator 230. The driving of the panel driver 260 changes transmittance of light at respective pixels disposed at the liquid crystal panels R, G, and B, forming an image.

The projection optical system driver 270 is configured to include a motor that drives a lens disposed in the projection optical system 400. The projection optical system driver 270 drives, for example, the projection optical system 400 in accordance with the control by the controller 210 to perform, for example, zoom adjustment, focus adjustment, aperture adjustment, and so on.

The projection optical system 400 includes: a lens group for projecting, on the screen 500, light modulated at the liquid crystal display panel 1 (each of the liquid crystal panels R, G, and B of the optical modulator 230) to form an image; and so on.

### Configuration Example of Projection-Type Display Unit

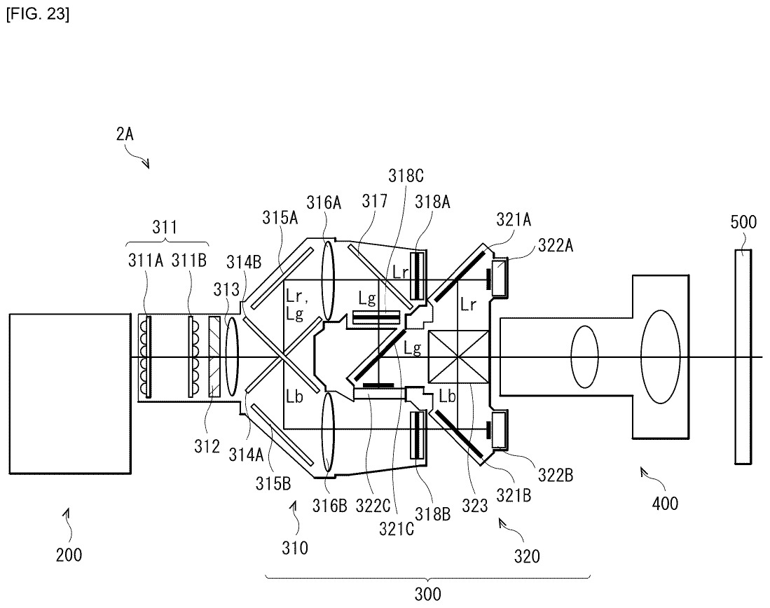

FIG. 23 is a schematic diagram illustrating another example (a projection-type display unit 2A) of an overall configuration of an optical system included in the projection-type display unit 2. The projection-type display unit 2A is a reflective 3 LCD projection-type display unit that performs light modulation with a reflective liquid crystal panel (Liquid Crystal Display (LCD)).

The projection-type display unit 2A includes a light source unit 200, an illumination optical system 310, an image forming section 320, and a projection optical system 400 in order just mentioned, as illustrated in FIG. 23.

The illumination optical system 310 has: for example, from a position near the light source unit 200, fly-eye lenses 311 (311A and 311B), polarization conversion device 312, a lens 313, dichroic mirrors 314A and 314B, reflective mirrors 315A and 315B, lenses 316A and 313B, a dichroic mirror 317, and polarizing plates 318A, 318B, and 318C.

The fly-eye lenses 311 (311A and 311B) uniformizes illuminance distribution of illumination light from the light source unit 200.

The polarization conversion device 312 functions to align polarization axes of incident light in a predetermined direction and, for example, converts randomly polarized light into P polarized light.

The lens 313 focuses light from the polarization conversion device 312 onto the dichroic mirrors 314A and 314B.

The dichroic mirrors 314A and 314B selectively reflect light in a predetermined wavelength range and selectively transmits light in wavelength ranges other than the aforementioned wavelength range. For example, the dichroic mirror 314A mainly reflects red light Lr and green light Lg towards the reflective mirror 315A. Moreover, the dichroic mirror 314B mainly reflects blue light Lb towards the reflective mirror 315B.

The reflective mirror 315A reflects light (mainly the red light Lr and the green light Lg) from the dichroic mirror 314A towards the lens 316A. The reflective mirror 315B reflects light (mainly the blue light Lb) from the dichroic mirror 314B towards the lens 316B.

The lens 316A transmits light (mainly the red light Lr and the green light Lg) from the reflective mirror 315A and focuses the light onto the dichroic mirror 317. The lens 316B transmits light (mainly the blue light Lb) from the reflective mirror 315B and focuses the light on the polarizing plate 318B.

The dichroic mirror 317 selectively reflects the green light Lg towards the polarizing plate 318C, and also selectively transmits light in wavelength ranges other than a wavelength range of the aforementioned light.

The polarizing plates 318A, 318B, and 318C include a polarizer having a polarization axis in a predetermined direction. For example, in a case where conversion into P polarized light is performed at the polarization conversion device 312, the polarizing plates 318A, 318B, and 318C transmit the P polarized light and reflects S polarized light.

The image forming section 320 has: reflective polarizing plates 321A, 321B, and 321C, liquid crystal panels 322A, 322B, and 322C, and a dichroic prism 323.

The reflective polarizing plates 321A, 321B, and 321C transmit corresponding light (for example, P polarized light) with the same polarization axis as a polarization axis of polarized light from the polarizing plates 318A, 318B, and 318C and reflects light (S polarized light) with other polarization axes. Specifically, the reflective polarizing plate 321A transmits the red light Lr of the P polarized light from the polarizing plate 318A towards the liquid crystal panel 322A. The reflective polarizing plate 321B transmits the blue light Lb of the P polarized light from the polarizing plate 318B towards the liquid crystal panel 322B. The reflective polarizing plate 321C transmits the green light Lg of the P polarized light from the polarizing plate 318C towards the liquid crystal panel 322C. Moreover, the reflective polarizing plate 321A reflects the red light Lr of the S polarized light from the liquid crystal panel 322A and makes the light enter the dichroic prism 323. The reflective polarizing plate 321B reflects the blue light Lb of the S polarized light from the liquid crystal panel 322B and makes the light enter the dichroic prism 323. The reflective polarizing plate 321C reflects the green light Lg of the S polarized light from the liquid crystal panel 322C and makes the light enter the dichroic prism 323.

The liquid crystal panels 322A, 322B, and 322C perform spatial modulation of the red light Lr, the blue light Lb, and the green light Lg, respectively, and correspond to the optical modulator 230 described above. The liquid crystal panels 322A, 322B, and 322C are electrically coupled to a signal source (for example, PC or the like), not illustrated, that supplies an image signal including image information. Based on supplied image signals of the respective colors, the liquid crystal panels 322A, 322B, and 322C modulate incident light for each pixel and respectively generate a red image, a green image, and a blue image.

The dichroic prism 323 synthesizes the incident red light Lr, blue light Lb, and green light Lg and outputs the light towards the projection optical system 400.

The projection optical system 400 has: for example, a plurality of lenses; and so on. The projection optical system 400 enlarges light exiting from the image forming section 320 and projects the light on. for example, the screen 500.

The present disclosure has been described above, referring to the embodiment and Modification Examples 1 to 6 as well as the application example. The present disclosure is not limited to the embodiment described above and so on, and various modification can be made thereto. For example, the liquid crystal display panel 1 and the projection-type display unit 2 of the present disclosure do not necessarily include all the components described in the embodiment described above and so on, and may include other layers. For example, a polarizing plate may be further provided on the light incidence side S1 of the counter substrate 20. The polarizing plate is, for example, crossed-Nicol disposed and permits the passage of only light in a predetermined vibration direction (polarized light) therethrough. The polarizing plate is formed by, for example, polyvinyl alcohol (PVA) to which iodine (I) compound molecules are adsorbed and oriented.

Moreover, the projection-type display unit 2 of a so-called three-plate type having the three liquid crystal panels (the liquid crystal panels 322A, 322B, and 322C) is illustrated in the application example described above, but the application is not limited thereto, and application to, for example, a projection-type display unit of a so-called two plate type having two liquid crystal panels and a projection-type display unit of a single plate type is also possible.

Further, the display unit of the present disclosure is also applicable to various display units of a type that modulates light from the light source through the liquid crystal display panel 1 (the optical modulator 230) and displays pictures using a projection lens. For example, the display unit of the present disclosure is applicable to a head up display, an Augmented Reality (AR) glass, and so on in addition to the projector (the projection-type display unit 2) described above.

Note that the effects described in the description are just illustrative and are not limited to those described and other effects may also be provided.

It is also possible to provide the present technique with a configuration as illustrated below. With the present technique with the configuration described below, a heat generating structure that absorbs incident light to generate heat is provided in a non-display region including a plurality of dummy pixels provided around a display region, where a plurality of effective pixels is disposed in a matrix form in a manner surrounding the display region is. This consequently uniformizes a temperature gradient in a plane of the display region. Therefore, it is possible to improve image quality.

### (1)

A display unit including:
a display region where a plurality of effective pixels is disposed in a matrix form;
a non-display region including a plurality of dummy pixels provided around the display region; and
a heat generating structure that is provided in the non-display region in a manner surrounding the display region and absorbs incident light to generate heat.

### (2)

The display unit according to the (1) described above, further including:
a first substrate that has the display region and the non-display region and is provided with: a plurality of first reflective electrodes respectively provided at the plurality of effective pixels; a plurality of second reflective electrodes respectively provided at the plurality of dummy pixels; and a pixel circuit that drives the plurality of effective pixels and the plurality of dummy pixels;
a second substrate disposed oppositely to the first substrate; and
a liquid crystal layer provided between the first substrate and the second substrate, in which
the heat generating structure is provided on a side of the first substrate.

### (3)

The display unit according to the (2) described above, in which
the heat generating structure includes: the second reflective electrodes respectively provided at the plurality of dummy pixels provided in the non-display region; and a first metal film formed in a region where the plurality of dummy pixels is disposed.

### (4)

The display unit according to the (2) or (3) described above, in which
an interval between the adjacent plurality of second reflective electrodes is wider than an interval between the adjacent plurality of first reflective electrodes.

### (5)

The display unit according to the (4) described above, in which
the interval between the adjacent plurality of second reflective electrodes is also wider with an increase in a distance from the display region.

### (6)

The display unit according to the (4) or (5) described above, in which
the plurality of first reflective electrodes and the plurality of second reflective electrodes are disposed at a same pitch; and
the plurality of second reflective electrodes has a smaller area than the plurality of first reflective electrodes.

### (7)

The display unit according to the (6) described above, in which
the area of the plurality of second reflective electrodes is smaller with an increase in the distance from the display region.

### (8)

The display unit according to any one of the (2) to (7) described above, in which
the plurality of second reflective electrodes and the plurality of first reflective electrodes have the same area; and
the pitch of the plurality of second reflective electrodes is wider than the pitch of the plurality of first reflective electrodes.

### (9)

The display unit according to the (8) described above, in which
the pitch of the plurality of second reflective electrodes is wider with an increase in the distance from the display region.

### (10)

The display unit according to any one of the (3) to (9) described above, in which
the first metal film is a wiring layer included in the pixel circuit provided below the reflective electrodes.

### (11)

The display unit according to any one of the (3) to (9) described above, in which
the first metal film is provided below the reflective electrodes and electrically floating.

### (12)

The display unit according to any one of the (3) to (11) described above, in which the first metal film is formed using any of titanium nitride, molybdenum, an alloy of tungsten and molybdenum, silicon, titanium, tungsten, zinc aluminum, and aluminum additive zinc oxide (ZAO).

### (13)

The display unit according to any one of the (1) to (12) described above further including:

The first substrate that has the display region and the non-display region and is provided with: the first reflective electrodes respectively provided at the plurality of effective pixels; the second reflective electrodes respectively provided at the plurality of dummy pixels; and the pixel circuit that drives the plurality of effective pixels and the plurality of dummy pixels;
the second substrate disposed oppositely to the first substrate; and
the liquid crystal layer provided between the first substrate and the second substrate, in which
the heat generating structure is provided on a side of the second substrate.

### (14)

The display unit according to the (13) described above, in which
the second substrate further has a common electrode continuous to the plurality of effective pixels and the plurality of dummy pixels, and
the heat generating structure includes a second metal film formed more closely to a light incidence side than the common electrode in the region where the plurality of dummy pixels is disposed.

### (15)

The display unit according to the (14) described above, in which
the common electrode has light transmittance, and
the second metal film is formed using any of titanium nitride, molybdenum, an alloy of tungsten and molybdenum, silicon, titanium, tungsten, zinc aluminum, and aluminum additive zinc oxide (ZAO).

### (16)

An electronic apparatus including
a display unit, in which
the display unit includes:
a display region where a plurality of effective pixels is disposed in a matrix form;
a non-display region including a plurality of dummy pixels provided around the display region; and
a heat generating structure that is provided in the non-display region in a manner surrounding the display region and absorbs incident light to generate heat.

The present application claims the benefit of Japanese Priority Patent Application JP2022-158947 filed with the Japan Patent Office on Sep. 30, 2022, the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof.

1. A display unit comprising:
a display region where a plurality of effective pixels is disposed in a matrix form;
a non-display region including a plurality of dummy pixels provided around the display region; and
a heat generating structure provided in the non-display region in a manner surrounding the display region, the heat generating structure absorbing incident light to generate heat.

2. The display unit according to claim 1, further comprising:
a first substrate having the display region and the non-display region, the first substrate being provided with: a plurality of first reflective electrodes; a plurality of second reflective electrodes; and a pixel circuit, the plurality of first reflective electrodes being respectively provided at the plurality of effective pixels, the plurality of second reflective electrodes being respectively provided at the plurality of dummy pixels, and the pixel circuit driving the plurality of effective pixels and the plurality of dummy pixels,
a second substrate disposed oppositely to the first substrate; and
a liquid crystal layer provided between the first substrate and the second substrate, wherein
the heat generating structure is provided on a side of the first substrate.

3. The display unit according to claim 2, wherein
the heat generating structure includes: the second reflective electrodes respectively provided at the plurality of dummy pixels provided in the non-display region; and a first metal film formed in a region where the plurality of dummy pixels is disposed.

4. The display unit according to claim 2, wherein
an interval between the adjacent plurality of second reflective electrodes is wider than an interval between the adjacent plurality of first reflective electrodes.

5. The display unit according to claim 4, wherein
the interval between the adjacent plurality of second reflective electrodes is also wider with an increase in a distance from the display region.

6. The display unit according to claim 4, wherein
the plurality of first reflective electrodes and the plurality of second reflective electrodes are disposed at a same pitch; and
the plurality of second reflective electrodes has a smaller area than the plurality of first reflective electrodes.

7. The display unit according to claim 6, wherein
the area of the plurality of second reflective electrodes is smaller with an increase in a distance from the display region.

8. The display unit according to claim 2, wherein
the plurality of second reflective electrodes and the plurality of first reflective electrodes have a same area; and
a pitch of the plurality of second reflective electrodes is wider than a pitch of the plurality of first reflective electrodes.

9. The display unit according to claim 8, wherein
the pitch of the plurality of second reflective electrodes is wider with an increase in a distance from the display region.

10. The display unit according to claim 3, wherein
the first metal film is a wiring layer included in the pixel circuit provided below the reflective electrodes.

11. The display unit according to claim 3, wherein
the first metal film is provided below the reflective electrodes and electrically floating.

12. The display unit according to claim 3, wherein
the first metal film is formed using any of titanium nitride, molybdenum, an alloy of tungsten and molybdenum, silicon, titanium, tungsten, zinc aluminum, and aluminum additive zinc oxide (ZAO).

13. The display unit according to claim 1 further comprising:
a first substrate having the display region and the non-display region, the first substrate being provided with: first reflective electrodes, second reflective electrodes, and a pixel circuit, the first reflective electrodes being respectively provided at the plurality of effective pixels, the second reflective electrodes being respectively provided at the plurality of dummy pixels, and the pixel circuit driving the plurality of effective pixels and the plurality of dummy pixels,
a second substrate disposed oppositely to the first substrate; and
a liquid crystal layer provided between the first substrate and the second substrate, wherein
the heat generating structure is provided on a side of the second substrate.

14. The display unit according to claim 13, wherein
the second substrate further has a common electrode continuous to the plurality of effective pixels and the plurality of dummy pixels, and
the heat generating structure includes a second metal film formed more closely to a light incidence side than the common electrode in a region where the plurality of dummy pixels is disposed.

15. The display unit according to claim 14, wherein
the common electrode has light transmittance, and
the second metal film is formed using any of titanium nitride, molybdenum, an alloy of tungsten and molybdenum, silicon, titanium, tungsten, zinc aluminum, and aluminum additive zinc oxide (ZAO).

16. An electronic apparatus comprising
a display unit, wherein
the display unit includes:
a display region where a plurality of effective pixels is disposed in a matrix form;
a non-display region including a plurality of dummy pixels provided around the display region; and
a heat generating structure provided in the non-display region in a manner surrounding the display region, the heat generating structure absorbing incident light to generate heat.
